(19) United States
(12) Patent Application Publication
(10) Pub. No.: US 2008/0215975 A1
(43) Pub. Date: Sep. 4, 2008

(54) Virtual world user opinion & response monitoring

(76) Inventors: Phil Harrison, London (GB); Gary M. Zalewski, Oakland, CA (US)

Correspondence Address: MARTINE PENILLA & GENCARELLA, LLP, 710 LAKEWAY DRIVE, SUITE 200, SUNNYVALE, CA, 94085, US

(21) Appl. No.: 11/789,326

(22) Filed: Apr. 23, 2007

Related U.S. Application Data
(60) Provisional application No. 60/892,397, filed on Mar. 1, 2007.

(51) Int. Cl. G06F 3/00

(52) U.S. Cl. 715/706

(57) ABSTRACT

Methods and systems for executing a network application is provided. The network application is defined to render a virtual environment, and the virtual environment is depicted by computer graphics. The method includes generating an animated user and controlling the animated user in the virtual environment. The method presents advertising objects in the virtual environment and detects actions by the animated user to determine if the animated user is viewing one of the advertising object in the virtual environment. Reactions of the animated user are captured when the animated user is viewing the advertising object. The reactions by the animated user within the virtual environment are those that relate to the advertising object, and are presented to a third party to determine effectiveness of the advertising object in the virtual environment. Additionally, actual reactions (e.g., physical, audible, or combinations) of the real-world user can be captured and analyzed, or captured and mapped to the avatar for analysis of the of the avatar response.

### CLAIM OF PRIORITY

This application claims priority to U.S. Provisional Patent Application No. 60/892,397, entitled “VIRTUAL WORLD COMMUNICATION SYSTEMS AND METHODS”, filed on Mar. 1, 2007, which is herein incorporated by reference.

### CROSS-REFERENCE TO RELATED APPLICATION

This application is related to: (1) U.S. patent application Ser. No. ______, (Attorney Docket No. SONYP066/SCEA06112US00) entitled “Interactive User Controlled Avatar Animations”, filed on the same date as the instant application, (2) U.S. patent application Ser. No. ______, (Attorney Docket No. SONYP067/SCEA06113US00) entitled “Virtual World Avatar Control, Interactivity and Communication Interactive Messaging”, filed on the same date as the instant application, (3) U.S. patent application Ser. No. 11/403,179 entitled “System and Method for Using User's Audio Environment to Select Advertising”, filed on 12 Apr. 2006, and (4) U.S. patent application Ser. No. 11/407,299 entitled “Using Visual Environment to Select Ads on Game Platform”, filed on 17 Apr. 2006, (5) U.S. patent application Ser. No. 11/682,281 entitled “System and Method for Communicating with a Virtual World”, filed on 5 Mar. 2007, (6) U.S. patent application Ser. No. 11/682,284 entitled “System and Method for Routing Communications Among Real and Virtual Communication Devices”, filed on 5 Mar. 2007, (7) U.S. patent application Ser. No. 11/682,287 entitled “System and Method for Communicating with an Avatar”, filed on 5 Mar. 2007, U.S. patent application Ser. No. 11/682,292 entitled “Mapping User Emotional State to Avatar in a Virtual World”, filed on 5 Mar. 2007, U.S. patent application Ser. No. 11/682,298 entitled “Avatar Customization”, filed on 5 Mar. 2007, and (8) U.S. patent application Ser. No. 11/682,299 entitled “Avatar Email and Methods for Communicating Between Real and Virtual Worlds”, filed on 5 Mar. 2007, each of which is hereby incorporated by reference.

### BACKGROUND

### Description of the Related Art

The video game industry has seen many changes over the years. As computing power has expanded, developers of video games have likewise created game software that takes advantage of these increases in computing power. To this end, video game developers have been coding games that incorporate sophisticated operations and mathematics to produce a very realistic game experience.

Example gaming platforms, may be the Sony Playstation or Sony Playstation2 (PS2), each of which is sold in the form of a game console. As is well known, the game console is designed to connect to a monitor (usually a television) and enable user interaction through handheld controllers. The game console is designed with specialized processing hardware, including a CPU, a graphics synthesizer for processing intensive graphics operations, a vector unit for performing geometry transformations, and other glue hardware, firmware, and software. The game console is further designed with an optical disc tray for receiving game compact discs for local play through the game console. Online gaming is also possible, where a user can interactively play against or with other users over the Internet.

As game complexity continues to intrigue players, game and hardware manufacturers have continued to innovate to enable additional interactivity and computer programs. Some computer programs define virtual worlds. A virtual world is a simulated environment in which users may interact with each other via one or more computer processors. Users may appear on a video screen in the form of representations referred to as avatars. The degree of interaction between the avatars and the simulated environment is implemented by one or more computer applications that govern such interactions as simulated physics, exchange of information between users, and the like. The nature of interactions among users of the virtual world is often limited by the constraints of the system implementing the virtual world.

It is within this context that embodiments of the invention arise.

### SUMMARY OF THE INVENTION

Broadly speaking, the present invention fills these needs by providing computer generated graphics that depict a virtual world. The virtual world can be traveled, visited, and interacted with using a controller or controlling input of a real-world computer user. The real-world user in essence is playing a video game, in which he controls an avatar (e.g., virtual person) in the virtual environment. In this environment, the real-world user can move the avatar, strike up conversations with other avatars, view content such as advertising, make comments or gestures about content or advertising.

In one embodiment, method for enabling interactive control and monitoring of avatars in a computer generated virtual world environment is provided. The method includes generating a graphical animated environment and presenting a viewable object within the graphical animated environment. Further provided is moving an avatar within the graphical animated environment, where the moving includes directing a field of view of the avatar toward the viewable object. A response of the avatar is detected when the field of view of the avatar is directed toward the viewable object. Further included is storing the response and the response is analyzed to determine whether the response by the avatar is more positive or more negative. In one example, the viewable object is an advertisement.

In another embodiment, a computer implemented method for executing a network application is provided. The network application is defined to render a virtual environment, and the virtual environment is depicted by computer graphics. The method includes generating an animated user and controlling the animated user in the virtual environment. The method presents advertising objects in the virtual environment and detects actions by the animated user to determine if the animated user is viewing one of the advertising object in the virtual environment. Reactions of the animated user are captured when the animated user is viewing the advertising object. The reactions by the animated user within the virtual environment are those that relate to the advertising object, and are presented to a third party to determine effectiveness of the advertising object in the virtual environment.

In one embodiment, a computer implemented method for executing a network application is provided. The network application is defined to render a virtual environment, and the virtual environment is depicted by computer graphics. The method includes generating an animated user and controlling the animated user in the virtual environment. The method presents advertising objects in the virtual environment and detects actions by the animated user to determine if the animated user is viewing one of the advertising object in the virtual environment. Reactions of the animated user are captured when the animated user is viewing the advertising object. The reactions by the animated user within the virtual environment are those that relate to the advertising object, and are presented to a third party to determine if the reactions are more positive or more negative.

Other aspects and advantages of the invention will become apparent from the following detailed description, taken in conjunction with the accompanying drawings, illustrating by way of example the principles of the invention.

### BRIEF DESCRIPTION OF THE DRAWINGS

The invention, together with further advantages thereof, may best be understood by reference to the following description taken in conjunction with the accompanying drawings.

FIG. 1A illustrates a virtual space, in accordance with one embodiment of the present invention.

FIG. 1B illustrates user sitting on a chair holding a controller and communicating with a game console, in accordance with one embodiment of the present invention.

FIGS. 1C-1D illustrate a location profile for an avatar that is associated with a user of a game in which virtual space interactivity is provided, in accordance with one embodiment of the present invention.

FIG. 2 illustrates a more detailed diagram showing the monitoring of the real-world user for generating feedback, as described with reference to in FIG. 1A, in accordance with one embodiment of the present invention.

FIG. 3A illustrates an example where controller and the buttons of the controller can be selected by a real-world user to cause the avatar's response to change, depending on the real-world user's approval or disapproval of advertisement, in accordance with one embodiment of the present invention.

FIG. 3B illustrates operations that may be performed by a program in response to user operation of a controller for generating button responses of the avatar when viewing specific advertisements or objects, or things within the virtual space.

FIGS. 4A-4C illustrate other controller buttons that may be selected from the left shoulder buttons and the right shoulder buttons to cause different selections that will express different feedback from an avatar, in accordance with one embodiment of the present invention.

FIG. 5 illustrates an embodiment where a virtual space may include a plurality of virtual world avatars, in accordance with one embodiment of the present invention.

FIG. 6 illustrates a flowchart diagram used to determine when to monitor user feedback, in accordance with one embodiment of the present invention.

FIG. 7A illustrates an example where user A is walking through the virtual space and is entering an active area, in accordance with one embodiment of the present invention.

FIG. 7B shows user A entering the active area, but having the field of view not focused on the screen, in accordance with one embodiment of the present invention.

FIG. 7C illustrates an example where user A is now focused in on a portion of the screen, in accordance with one embodiment of the present invention.

FIG. 7D illustrates an example where user is fully viewing the screen and is within the active area, in accordance with one embodiment of the present invention.

FIG. 8A illustrates an embodiment where users within a virtual room may be prompted to vote as to their likes or dislikes, regarding a specific ad, in accordance with one embodiment of the present invention.

FIG. 8B shows users moving to different parts of the room to signal their approval or disapproval, or likes or dislikes, in accordance with one embodiment of the present invention.

FIG. 8C shows an example of users voting YES or NO by raising their left or right hands, in accordance with one embodiment of the present invention.

FIG. 9 schematically illustrates the overall system architecture of the Sony® Playstation 3® entertainment device, a console having controllers for implementing an avatar control system in accordance with one embodiment of the present invention.

FIG. 10 is a schematic of the Cell processor in accordance with one embodiment of the present invention.

### DETAILED DESCRIPTION

Embodiments of computer generated graphics that depict a virtual world are provided. The virtual world can be traveled, visited, and interacted with using a controller or controlling input of a real-world computer user. The real-world user in essence is playing a video game, in which he controls an avatar (e.g., virtual person) in the virtual environment. In this environment, the real-world user can move the avatar, strike up conversations with other avatars, view content such as advertising, make comments or gestures about content or advertising.

In one embodiment, program instructions and processing is performed to monitor any comments, gestures, or interactions with object of the virtual world. In another embodiment, monitoring is performed upon obtaining permission from users, so that users have control of whether their actions are tracked. In still another embodiment, if the user's actions are tracked, the user's experience in the virtual world may be enhanced, as the display and rendering of data for the user is more tailored to the users likes and dislikes. In still another embodiment, advertisers will learn what specific users like, and their advertising can be adjusted for specific users or for types of users (e.g., teenagers, young adults, kids (using kid-rated environments), adults, and other demographics, types or classes).

The information of user response to specific ads can also be provided directly to advertisers, game developers, logic engines, and suggestion engines. In this manner, advertisers will have a better handle on the customer likes, dislikes, and may be better suited to provide types of ads to specific users, and game/environment developers and owners can apply correct charges to advertisers based on use by users, selection by users, activity by users, reaction by users, viewing by users, etc.

In the following description, numerous specific details are set forth in order to provide a thorough understanding of the present invention. It will be apparent, however, to one skilled in the art that the present invention may be practiced without some or all of these specific details. In other instances, well known process steps have not been described in detail in order not to obscure the present invention.

According to an embodiment of the present invention users may interact with a virtual world. As used herein the term virtual world means a representation of a real or fictitious environment having rules of interaction simulated by means of one or more processors that a real user may perceive via one or more display devices and/or may interact with via one or more user interfaces. As used herein, the term user interface refers to a real device by which a user may send inputs to or receive outputs from the virtual world. The virtual world may be simulated by one or more processor modules. Multiple processor modules may be linked together via a network. The user may interact with the virtual world via a user interface device that can communicate with the processor modules and other user interface devices via a network. Certain aspects of the virtual world may be presented to the user in graphical form on a graphical display such as a computer monitor, television monitor or similar display. Certain other aspects of the virtual world may be presented to the user in audible form on a speaker, which may be associated with the graphical display.

Within the virtual world, users may be represented by avatars. Each avatar within the virtual world may be uniquely associated with a different user. Optionally, the name or pseudonym of a user may be displayed next to the avatar so that users may readily identify each other. A particular user's interactions with the virtual world may be represented by one or more corresponding actions of the avatar. Different users may interact with each other in the public space via their avatars. An avatar representing a user could have an appearance similar to that of a person, an animal or an object. An avatar in the form of a person may have the same gender as the user or a different gender. The avatar may be shown on the display so that the user can see the avatar along with other objects in the virtual world.

Alternatively, the display may show the world from the point of view of the avatar without showing itself. The user's (or avatar's) perspective on the virtual world may be thought of as being the view of a virtual camera. As used herein, a virtual camera refers to a point of view within the virtual world that may be used for rendering two-dimensional images of a 3D scene within the virtual world. Users may interact with each other through their avatars by means of the chat channels associated with each lobby. Users may enter text for chat with other users via their user interface. The text may then appear over or next to the user's avatar, e.g., in the form of comic-book style dialogue bubbles, sometimes referred to as chat bubbles. Such chat may be facilitated by the use of a canned phrase chat system sometimes referred to as quick chat. With quick chat, a user may select one or more chat phrases from a menu.

In embodiments of the present invention, the public spaces are public in the sense that they are not uniquely associated with any particular user or group of users and no user or group of users can exclude another user from the public space. Each private space, by contrast, is associated with a particular user from among a plurality of users. A private space is private in the sense that the particular user associated with the private space may restrict access to the private space by other users. The private spaces may take on the appearance of familiar private real estate.

Moving the avatar representation of user A 102b about the conceptual virtual space can be dictated by a user moving a controller of a game console and dictating movements of the avatar in different directions so as to virtually enter the various spaces of the conceptual virtual space. For more information on controlling avatar movement, reference may be made to U.S. patent application Ser. No. ______ (Attorney Docket No. SONYP066), entitled “INTERACTIVE USER CONTROLLED AVATAR ANIMATIONS”, filed on the same day as the instant application and assigned to the same assignee, is herein incorporated by reference. Reference may also be made to: (1) United Kingdom patent application no. 0703974.6 entitled “ENTERTAINMENT DEVICE”, filed on Mar. 1, 2007; (2) United Kingdom patent application no. 0704225.2 entitled “ENTERTAINMENT DEVICE AND METHOD”, filed on Mar. 5, 2007; (3) United Kingdom patent application no. 0704235.1 entitled “ENTERTAINMENT DEVICE AND METHOD”, filed on Mar. 5, 2007; (4) United Kingdom patent application no. 0704227.8 entitled “ENTERTAINMENT DEVICE AND METHOD”, filed on Mar. 5, 2007; and (5) United Kingdom patent application no. 0704246.8 entitled “ENTERTAINMENT DEVICE AND METHOD”, filed on Mar. 5, 2007, each of which is herein incorporated by reference.

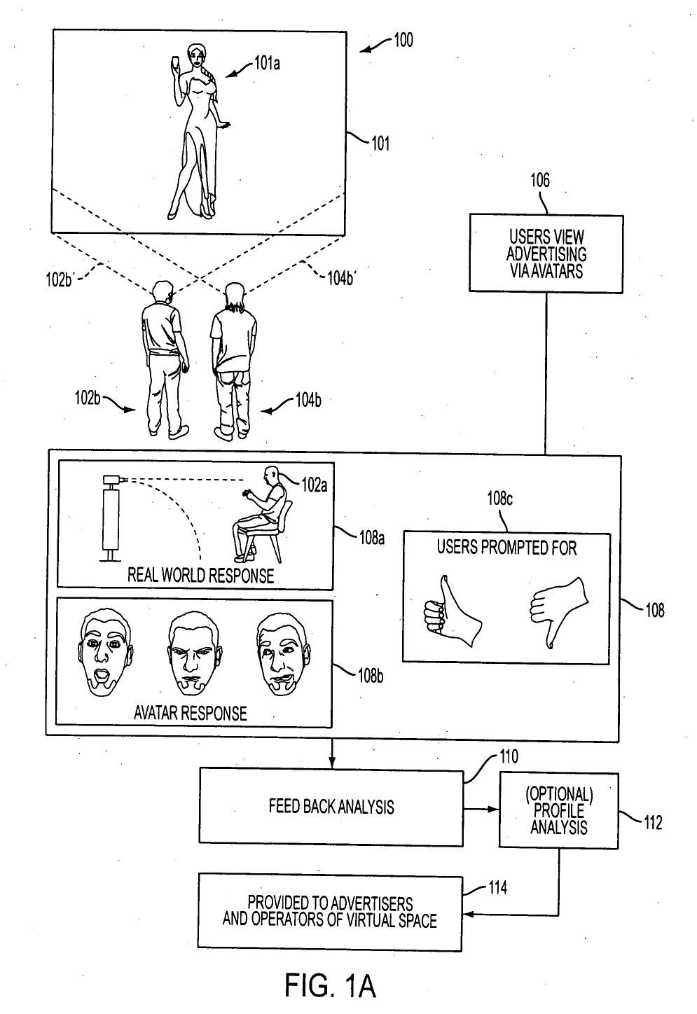

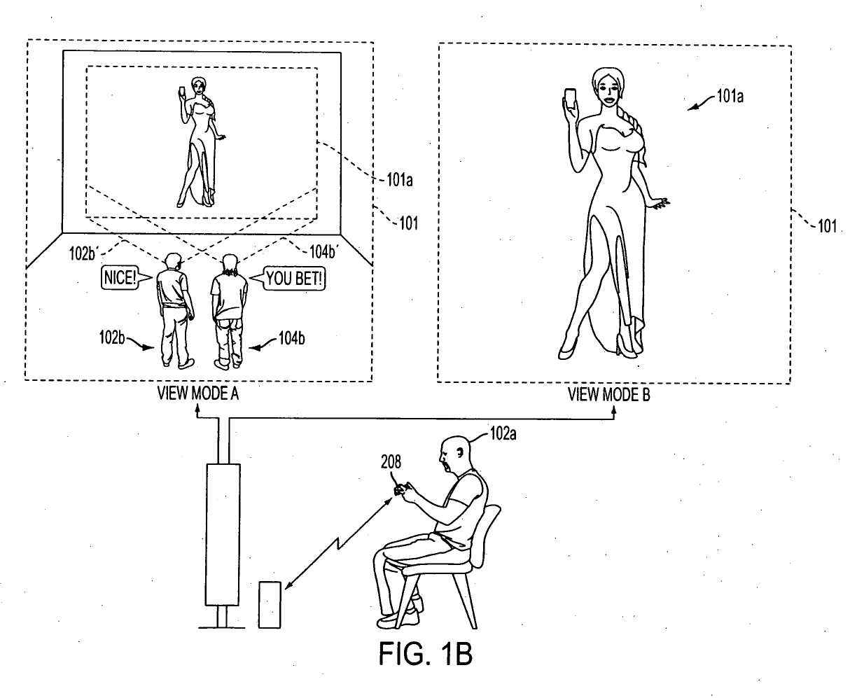

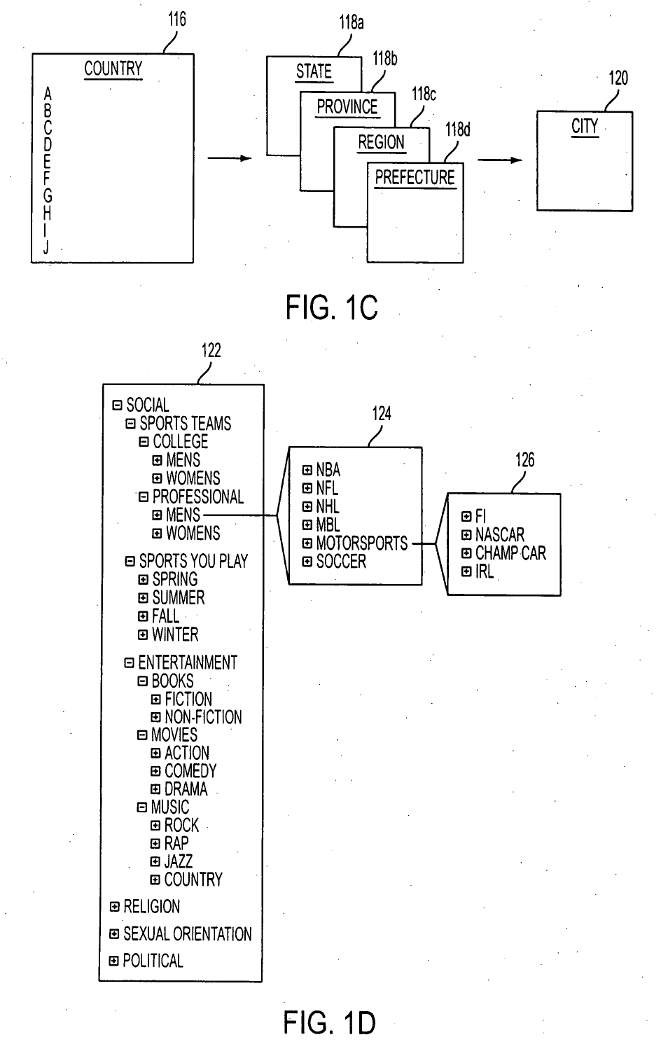

FIG. 1A illustrates a virtual space 100, in accordance with one embodiment of the present invention. The virtual space 100 is one where avatars are able to roam, congregate, and interact with one another and/or objects of a virtual space. Avatars are virtual world animated characters that represent or are correlated to a real-world user which may be playing an interactive game. The interactive game may require the real-world user to move his or her avatar about the virtual space 100 so as to enable interaction with other avatars (controlled by other real-world users or computer generated avatars), that may be present in selected spaces within the virtual space 100.

The virtual space 100 shown in FIG. 1A shows the avatars user A 102b and user B 104b. User A 102b is shown having a user field of view 102b′ while user B 104b is shown having a user B field of view 104b′. In the example shown, user A and user B are in the virtual space 100, and focused on an advertisement 101. Advertisement 101 may include a model person that is holding up a particular advertising item (e.g., product, item, object, or other image of a product or service), and is displaying the advertising object in an animated video, still picture, or combinations thereof. In this example, advertisement 101 may portray a sexy model for model 101a, so as to attract users that may be roaming or traveling across a virtual space 100. Other techniques for attracting avatar users, as is commonly done in advertising, may also be included as part of this embodiment.

Still further, model 101a could be animated and could move about a screen within the virtual space 100 or can jump out of the virtual screen and join the avatars. As the model 101a moves about in the advertisement, user A and user B are shown tracking their viewing toward this particular advertisement 101. It should be noted that the field of view of each of the users (avatars) can be tracked by a program executed by a computing system so as to determine where within the virtual space 100 the users are viewing, and/or what duration, what their gestures might be while viewing the advertisement 101, etc. Operation 106 is shown where processing is performed to determine whether users (e.g., avatars), are viewing advertisements via the avatars that define user A 102b and user B104b. 108 illustrates processing performed to detect and monitor real-world user feedback 108a and to monitor user controlled avatar feedback 108b.

Additionally, real-world users can select specific keys on controllers so as to graphically illustrate their approval or disapproval in a graphical form using user-prompted thumbs up or user-prompted thumbs down 108c. The real-world response of a real-world user 102a playing a game can be monitored in a number of ways. The real-world user may be holding a controller while viewing a display screen. The display screen may provide two views.

One view may be from the standpoint of the user avatar and the avatar's field of view, while the other view may be from the perspective of the avatar, as if the real-world user were floating behind the avatar (such as the view of the avatar from the avatar's backside).

In one embodiment, if the real-world user frowns, becomes excited, makes facial expressions, these gestures, comments and/or facial expressions may be tracked by a camera that is part of a real-world system. The real-world system may be connected to a computing device (e.g., such as a game console, or general computer(s)), and a camera that is interfaced with the game console. Based on the user's reaction to the game, or the content being viewed by the avatars being controlled by the real-world user, the camera in the real-world environment will track the real-world user's 102a facial expressions, sounds, frowns, or general excitement or non-excitement during the experience. The experience may be that of the avatar that is moving about the virtual space 100 and as viewed by the user in the real-world.

In this embodiment, a process may be executed to collect real-world and avatar response. If the real-world user 102a makes a gesture that is recognized by the camera, those gestures will be mapped to the face of the avatar. Consequently, real-world user facial expressions, movements, and actions, if tracked, can be interpreted, and assigned to particular aspects of the avatar. If the real-world user laughs, the avatar laughs, if the real-world user jumps, the avatar jumps, if the real-world user gets angry, the avatar gets angry, if the real-world user moves a body part, the avatar moves a body part. This, in this embodiment, is not necessary for the user to interface with a controller, but the real-world user, by simply moving, reacting, etc., can cause the avatar to do the same as the avatar moves about the virtual spaces.

In another embodiment, the monitoring may be performed of user-controlled avatar feedback 108b. In this embodiment, depending on the real-world user's enjoyment or non-enjoyment of a particular advertisement, object, or sensory response when roaming or traveling throughout the virtual space 100, the real-world user can decide to select certain buttons on the controller to cause the avatar to display a response. As shown in 108b, the real-world user may select a button to cause the avatar to laugh, frown, look disgusted, or generally produce a facial and/or body response. Depending on the facial and/or body response that is generated by the avatar or the real-world responses captured of the real-world user, this information can be fed back for analysis in operation 110. In one embodiment, users will be asked to approve monitoring of their response, and if monitored, their experience may be enhanced, as the program and computing system(s) can provide an environment that shapes itself to the likes, dislikes, etc. of the specific users or types of users.

In one embodiment, the analysis is performed by a computing system(s) (e.g., networked, local or over the internet), and controlled by software that is capable of determining the button(s) selected by the user and the visual avatar responses, or the responses captured by the camera or microphone of the user in the real-world. Consequently, if the avatars are spending a substantial amount of time in front of particular advertisements in the virtual space 100, that amount of time spent by the avatars (as controlled by real-world users), and the field of view captured by the avatars in the virtual space is tracked. This tracking allows information regarding the user's response to the particular advertisements, objects, motion pictures, or still pictures that may be provided within the virtual space 100. This information being tracked is then stored and organized so that future accesses to this database can be made for data analysis. Operation 112 is an optional operation that allows profile analysis to be accessed by the computing system in addition to the analysis obtained from the feedback in operation 110.

Profile analysis 112 is an operation that allows the computing system to determine pre-defined likes, dislikes, geographic locations, languages, and other attributes of a particular user that may be visiting a virtual space 100. In this manner, in addition to monitoring what the avatars are looking at, their reaction and feedback, this additional information can be profiled and stored in a database so that data mining can be done and associated with the specific avatars viewing the content.

For instance, if certain ads within a virtual space are only viewed by users between the ages of 15 to 29, this information may be useful as an age demographic for particular ads and thus, would allow advertisers to re-shape their ads or emphasize their ads for specific age demographics the visit particular spaces. Other demographics and profile information can also be useful to properly tailor advertisements within the virtual space, depending on the users visiting those types of spaces. Thus, based on the analyzed feedback 110 and the profile analysis (which is optional) in operation 112, the information that is gathered can be provided to advertisers and operators of the virtual space in 114.

FIG. 1B illustrates user 102a sitting on a chair holding a controller and communicating with a game console, in accordance with one embodiment of the present invention. User 102a, being the real-world user, will have the option of viewing his monitor and the images displayed on the monitor, in two modes. One mode may be from the eyes of the real-world user, showing the backside of user A 102b, which is the avatar. The user A 102b avatar has a field of view 102b′ while user B has a filed of view 104b′.

If the user 102a, being the real-world user, wishes to have the view from the eyes of the virtual user (i.e., the avatar), the view will be a closer-up view showing what is within the field of view 102b′ of the avatar 102b. Thus, the screen 101 will be a magnification of the model 101a which more clearly shows the view from the eyes of the avatar controlled by the real-world user. The real-world user can then switch between mode A (from behind the avatar), or mode B (from the eyes of the virtual user avatar). In either embodiment, the gestures of the avatar as controlled by the real-world user will be tracked as well as the field of view and position of the eyes/head of the avatar within the virtual space 100.

FIG. 1C illustrates a location profile for an avatar that is associated with a user of a game in which virtual space interactivity is provided. In order to narrow down the location in which the user wishes to interact, a selection menu may be provided to allow the user to select a profile that will better define the user's interests and the types of locations and spaces that may be available to the user. For example, the user may be provided with a location menu 116. Location menu 116 may be provided with a directory of countries that may be itemized by alphabetical order.

The user would then select a particular country, such as Japan, and the user would then be provided a location sub-menu 118. Location sub-menu 118 may ask the user to define a state 118a, a province 118b, a region 118c, or a prefecture 1118d, depending on the location selected. If the country that was selected was Japan, Japan is divided into prefectures 118d, that represent a type of state within the country of Japan. Then, the user would be provided with a selection of cities 120.

Once the user has selected a particular city within a prefecture, such as Tokyo, Japan, the user would be provided with further menus to zero down into locations and virtual spaces that may be applicable to the user. FIG. 1D illustrates a personal profile for the user and the avatar that would be representing the user in the virtual space. In this example, a personal profile menu 122 is provided. The personal profile menu 122 will list a plurality of options for the user to select based on the types of social definitions associated with the personal profile defined by the user. For example, the social profile may include sports teams, sports e-play, entertainment, and other sub-categories within the social selection criteria. Further shown is a sub-menu 124 that may be selected when a user selects a professional men's sports team, and additional sub-menus 126 that may define further aspects of motor sports.

Further illustrated are examples to allow a user to select a religion, sexual orientation, or political preference. The examples illustrated in the personal profile menu 122 are only exemplary, and it should be understood that the granularity and that variations in profile selection menu contents may change depending on the country selected for the user using the location menu 116 of FIG. 1C, the sub-menus 118, and the city selector 120. In one embodiment, certain categories may be partially or completely filled based on the location profile defined by the user. For example, the Japanese location selection could load a plurality of baseball teams in the sports section that may include Japanese league teams (e.g., Nippon Baseball League) as opposed to U.S. based Major League Baseball (MLB™) teams.

Similarly, other categories such as local religions, politics, politicians, may be partially generated in the personal profile selection menu 122 based on the users prior location selection in FIG. 1C. Accordingly, the personal profile menu 122 is a dynamic menu that is generated and is displayed to the user with specific reference to the selections of the user in relation to the where the user is located on the planet. Once the avatar selections have been made for the location profile in FIG. 1C and the personal profile in FIG. 1D, the user controlling his or her avatar can roam around, visit, enter, and interact with objects and people within the virtual world. In addition to visiting real-world counter-parts in the virtual world, it is also possible that categories of make belief worlds can be visited. Thus, profiles and selections may be for any form, type, world, or preference, and the example profile selector shall not limit the possibilities in profiles or selections.

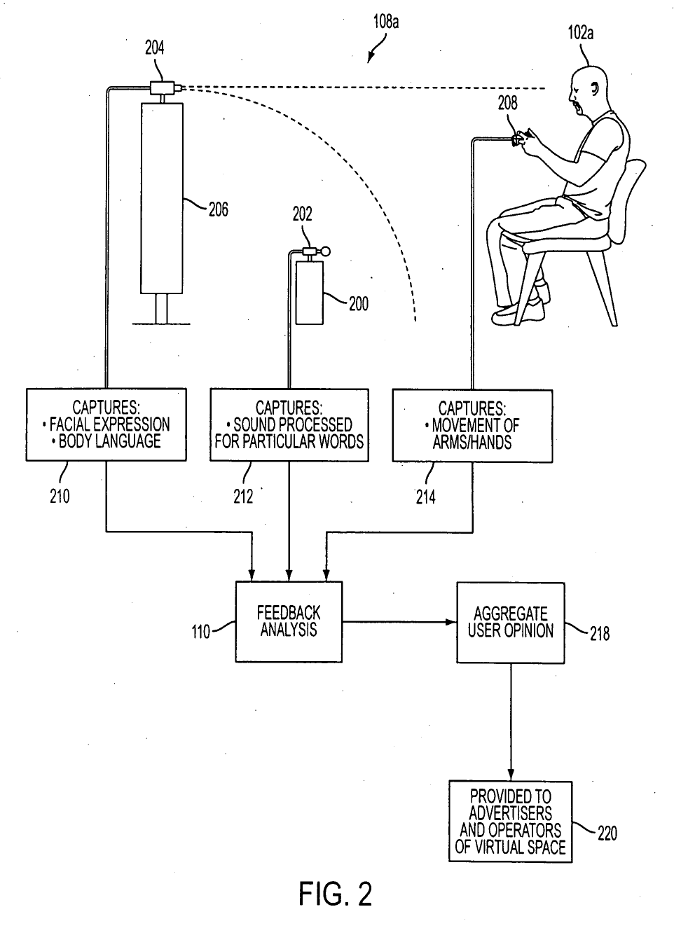

FIG. 2 illustrates a more detailed diagram showing the monitoring of the real-world user for generating feedback, as described with reference to 108a in FIG. 1A. The real-world user 102a may be sitting on a chair holding a controller 208. The controller 208 can be wireless or wired to a computing device. The computing device can be a game console 200 or a general computer. The console 200 is capable of connecting to a network. The network may be a wide-area-network (or internet) which would allow some or all processing to be performed by a program running over the network.

In one embodiment, one or more servers will execute a game program that will render objects, users, animation, sounds, shading, textures, and other user interfaced reactions, or captures based on processing as performed on networked computers. In this example, user 102a holds controller 208 which movements of the controller buttons are captured in operation 214. The movement of the arms and hands and buttons are captured, so as to capture motion of the controller 208, buttons of the controller 208, and six-axis dimensional rotation of the controller 208. Example six-axis positional monitoring may be done using an inertial monitor. Additionally, controller 208 may be captured in terms of sound by a microphone 202, or by position, lighting, or other input feedback by a camera 204. Display 206 will render a display showing the virtual user avatar traversing the virtual world and the scenes of the virtual world, as controlled by user 102a. Operation 212 is configured to capture the sound processed for particular words by user 102a.

For instance, if user 102a becomes excited or sad or utters specific gestures while the avatar that is being controlled traverses the virtual space 100, the microphone 202 will be configured to capture that information so that the sound may be processed for identifying particular words or information. Voice recognition may also be performed to determine what is said in particular spaces, if users authorize capture. As noted, camera 204 will capture the gestures by the user 102a, movements by controller 208, facial expressions by user 102a, and general feedback excitement or non-excitement.

Camera 204 will then provide capture of facial expressions, body language, and other information in operation 210. All of this information that is captured in operations, 210, 212, and 214, can be provided as feedback for analysis 110, as described with reference to FIG. 1A. The aggregated user opinion is processed in operation 218 that will organize and compartmentalize the aggregated responses by all users that may be traveling the virtual space and viewing the various advertisements within the virtual spaces that they enter. This information can then be parsed and provided in operation 220 to advertisers and operators of the virtual space.

This information can be provide guidance to the advertisers as to who is viewing the advertisements, how long they viewed the advertisements, their gestures made in front of the advertisements, their gestures made about the advertisements, and will also provide operators of the virtual space metric by which to possibly charge for the advertisements within the virtual spaces, as depending on their popularity, views by particular users, and the like.

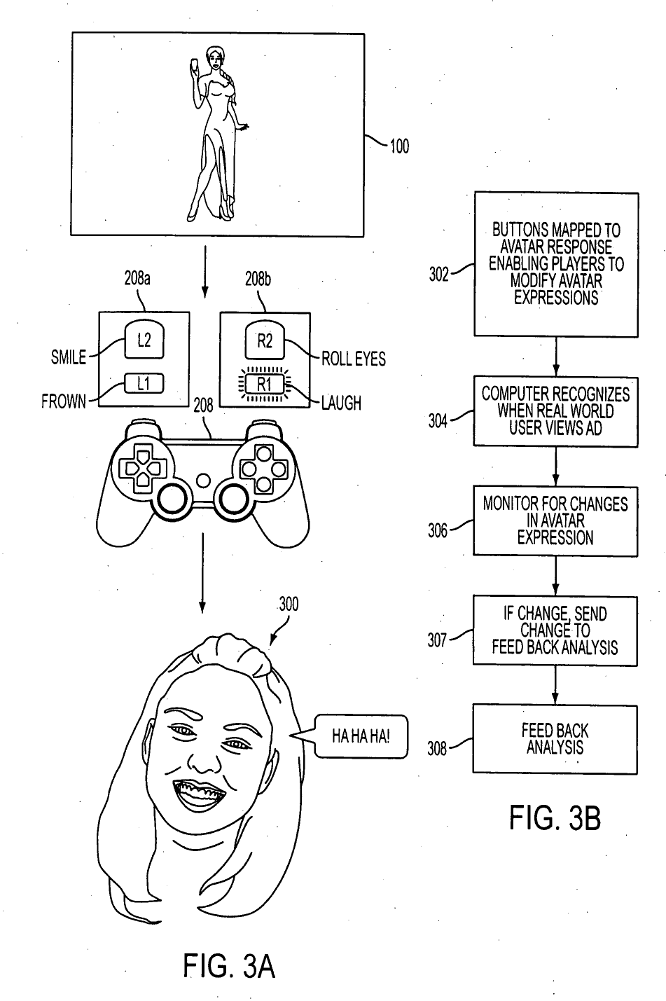

FIG. 3A illustrates an example where controller 208 and the buttons of the controller 208 can be selected by a real-world user to cause the avatar's response 300 to change, depending on the real-world user's approval or disapproval of advertisement 100. Thus, user controlled avatar feedback is monitored, depending on whether the avatar is viewing the advertisement 100 and the specific buttons selected on controller 208 when the avatar is focusing in on the advertisement 100. In this example, the real-world user that would be using controller 208 (not shown), could select R1 so that the avatar response 300 of the user's avatar is a laugh (HA HA HA!).

As shown, other controller buttons such as left shoulder buttons 208a and right shoulder buttons 208b can be used for similar controls of the avatar. For instance, the user can select L2 to smile, L1 to frown, R2 to roll eyes, and other buttons for producing other avatar responses 300. FIG. 3B illustrates operations that may be performed by a program in response to user operation of a controller 208 for generating button responses of the avatar when viewing specific advertisements 100 or objects, or things within the virtual space. Operation 302 defines buttons that are mapped to avatar facial response to enable players to modify avatar expressions.

The various buttons on a controller can be mapped to different responses, and the specific buttons and the specific responses by the avatar can be changed, depending on the user preferences of buttons, or dependent on user preferences. Operation 304 defines detection of when a player (or a user) views a specific ad and the computing device would recognize that the user is viewing that specific ad. As noted above, the avatar will have a field of view, and that field of view can be monitored, depending on where the avatar is looking within the virtual space.

As the computing system (and computer program controlling the computer system) is constantly monitoring the field of view of the avatars within the virtual space, it is possible to determine when the avatar is viewing specific ads. If a user is viewing a specific ad that should be monitored for facial responses, operation 306 will define monitoring of the avatar for changes in avatar facial expressions. If the user selects for the avatar to laugh at specific ads, this information will be taken in by the computing system and stored to define how specific avatars responded to specific ads.

Thus, operations 307 and 308 will be continuously analyzed to determine all changes and facial expressions, and the information is fed back for analysis. The analysis performed on all the facial expressions can be off-line or in real time. This information can then be passed back to the system and then populated to specific advertisers to enable data mining, and re-tailoring of specific ads in response to their performance in the virtual space.

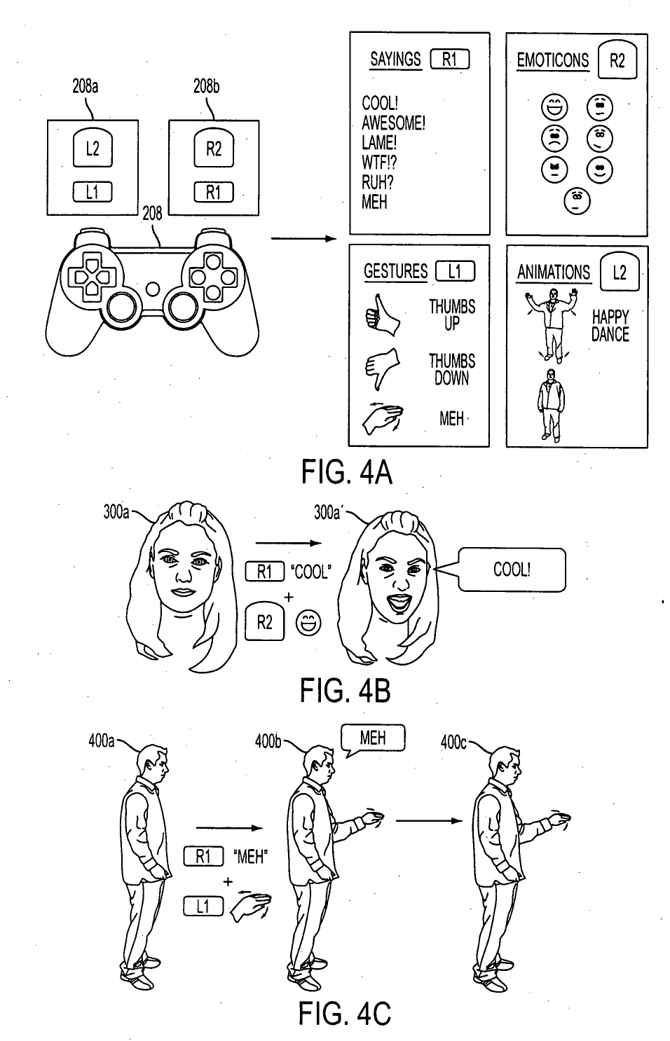

FIG. 4A illustrates other controller 208 buttons that may be selected from the left shoulder buttons 208a and the right shoulder buttons 208b to cause different selections that will express different feedback from an avatar. For instance, a user can scroll through the various sayings and then select the sayings that they desire by pushing button R1. The user can also select through different emoticons to select a specific emoticon and then select button R2.

The user can also select the various gestures and then select the specific gesture using L1, and the user can select different animations and then select button L2. FIG. 4B illustrates the avatar controlled by a real-world user which then selects the saying “COOL” and then selecting button R1. The real-world user can also select button R2 in addition to R1 to provide an emoticon together with a saying. The result is the avatar will smile and say “COOL”. The avatar saying “cool” can be displayed using a cloud or it could be output by the computer by a sound output. FIG. 4C illustrates avatar 400a where the real-world user selected button R1 to select “MEH” plus L1 to illustrate a hand gesture. The result will be avatar 400b and 400c where the avatar is saying “MEH” in a cloud and is moving his hand to signal a MEH expression. The expression of MEH is an expression of indifference or lack of interest.

Thus, if the avatar is viewing a specific advertisement within the virtual space and disapproves or is basically indifferent of the content, the avatar can signal with a MEH and a hand gesture. Each of these expressions, whether they are sayings, emoticons, gestures, animations, and the like, are tracked if the user is viewing a specific advertisement and such information is captured so that the data can be provided to advertisers or the virtual world creators and/or operators.

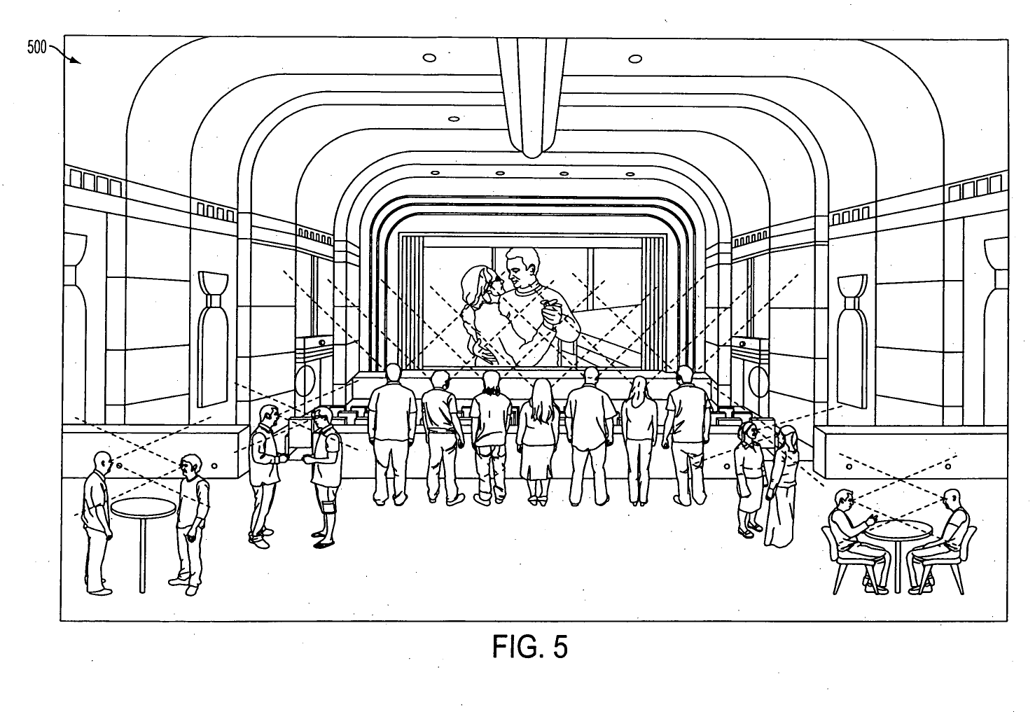

FIG. 5 illustrates an embodiment where a virtual space 500 may include a plurality of virtual world avatars. Each of the virtual world avatars will have their own specific field of view, and what they are viewing is tracked by the system. If the avatars are shown having discussions amongst themselves, that information is tracked to show that they are not viewing a specific advertisement, object, picture, trailer, or digital data that may be presented within the virtual space.

In one embodiment, a plurality of avatars are shown viewing a motion picture within a theater. Some avatars are not viewing the picture and thus, would not be tracked to determine their facial expressions. Users controlling their avatars can then move about the space and enter into locations where they may or may not be viewing a specific advertisement. Consequently, the viewer's motions, travels, field of views, and interactions can be monitored to determine whether the users are actively viewing advertisements, objects, or interacting with one another.

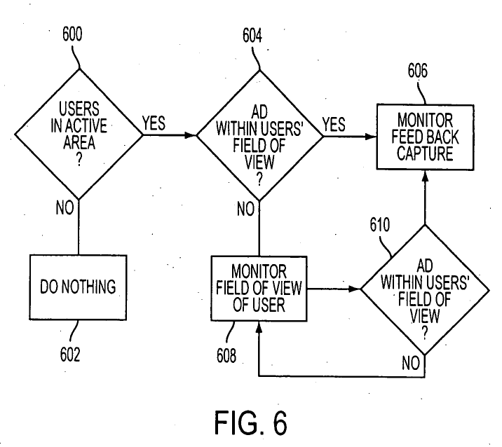

FIG. 6 illustrates a flowchart diagram used to determine when to monitor user feedback. In the virtual space, an active area needs to be defined. The active area can be defined as an area where an avatar feedback is monitored. Active area can be sized based on an advertisement size, ad placement, active areas can be overlapped, and the like. Once an active area is monitored for the field of view of the avatar, the viewing by the avatar can be logged as to how long the avatar views the advertisement, spends in a particular area in front of an advertisement, and the gestures made by the avatar when viewing the advertisement.

Operation 600 shows a decision where avatar users are determined to be in or out of an active area. If the users are not in the active area, then operation 602 is performed where nothing is tracked of the avatar. If the user is in the active area, then that avatar user is tracked to determine if the user's field of view if focusing in on an advertisement within the space in operation 604. If the user is not focusing on any advertisement or object that should be tracked in operation 604, then the method moves to operation 608.

In operation 608, the system will continue monitoring the field of view of the user. The method will continuously move to operation 610 where it is determined whether the user's field of view is now on the ad. If it is not, the method moves back to operation 608. This loop will continue until, in operation 610 it is determined that the user is viewing the ad, and the user is within the active area. At that point, operation 606 will monitor feedback capture of the avatar when the avatar is within the active area, and the avatar has his or her field of view focused on the ad.

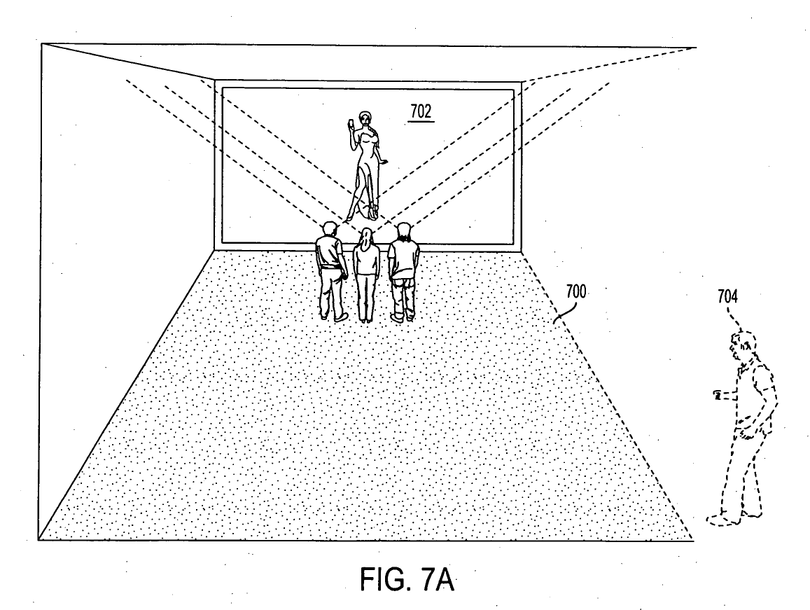

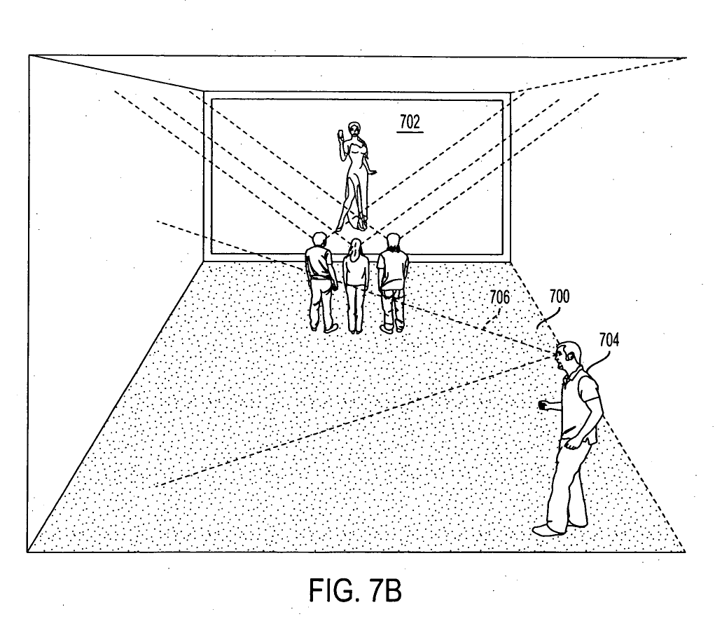

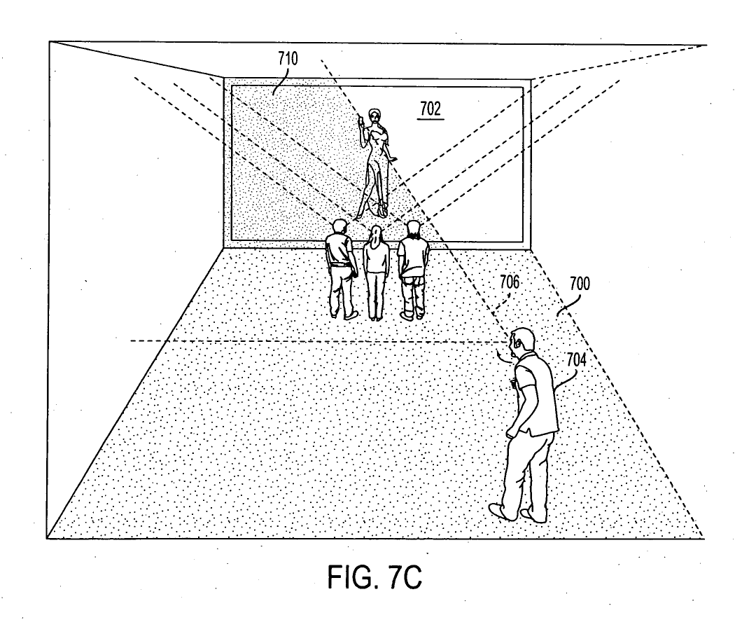

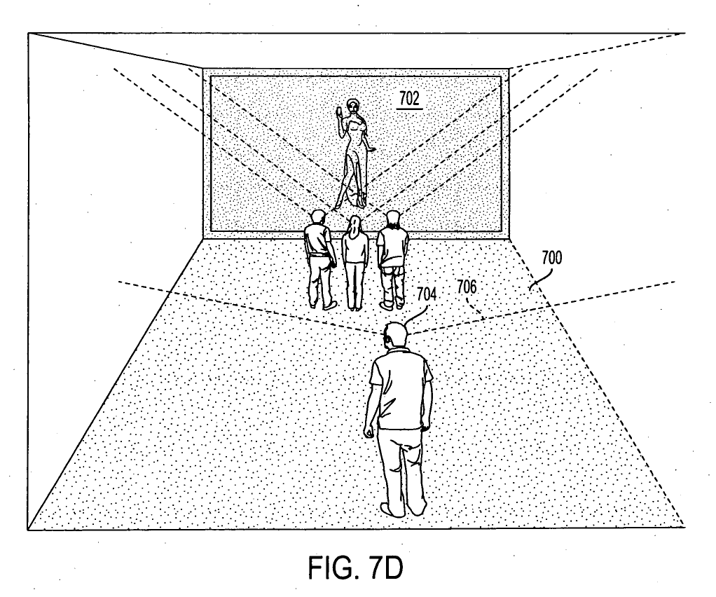

FIG. 7A illustrates an example where user A 704 is walking through the virtual space and is entering an active area 700. Active area 700 may be a specific room, a location within a room, or a specific space within the virtual space. As shown, user A 704 is walking in a direction of the active area 700 where three avatar users are viewing a screen or ad 702. The three users already viewing the screen 702 will attract others because they are already in the active area 700, and their field of view is focused on the screen that may be running an interesting ad for a service or product.

FIG. 7B shows user A 704 entering the active area 700, but having the field of view 706 not focused on the screen 702. Thus, the system will not monitor the facial expressions or bodily expressions, or verbal expressions by the avatar 704, because the avatar 704 is not focused in on the screen 702 where an ad may be running and user feedback of his expressions would be desired.

FIG. 7C illustrates an example where user A 704 is now focused in on a portion of the screen 710. The field of view 706 shows the user A's 704 field of view only focusing in on half of the screen 702. If the ad content is located in area 710, then the facial expressions and feedback provided by user A 704 will be captured. However, if the advertisement content is on the screen 702 in an area not covered by his field of view, that facial expression and feedback will not be monitored.

FIG. 7D illustrates an example where user 704 is fully viewing the screen 702 and is within the active area 700. Thus, the system will continue monitoring the feedback from user A and only discontinued feedback monitoring of user A when user A leaves the active area. In another embodiment, the user A's feedback can be discontinued for monitoring feedback if the particular advertisement is shown on the screen 702 ends, or is no longer in session.

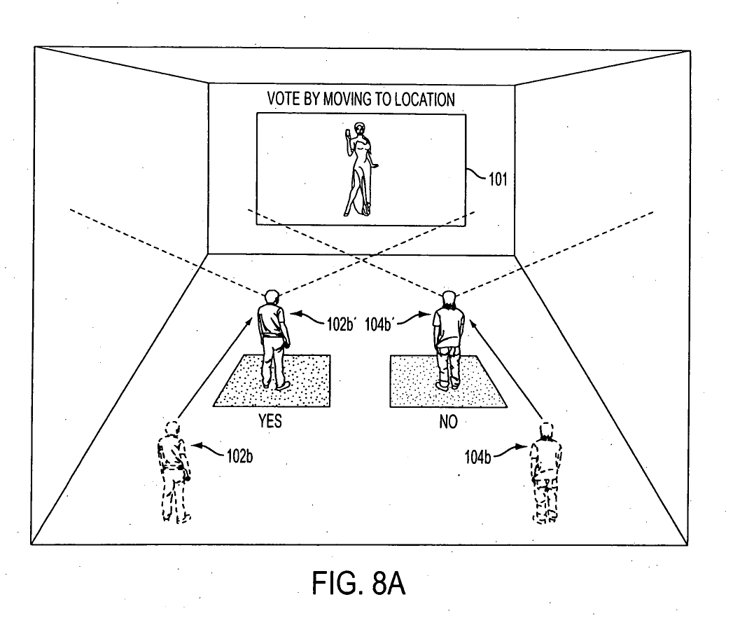

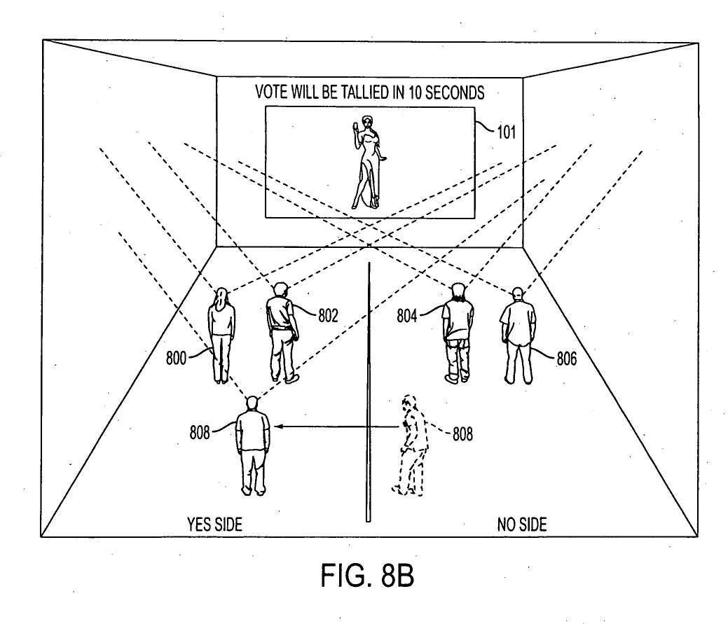

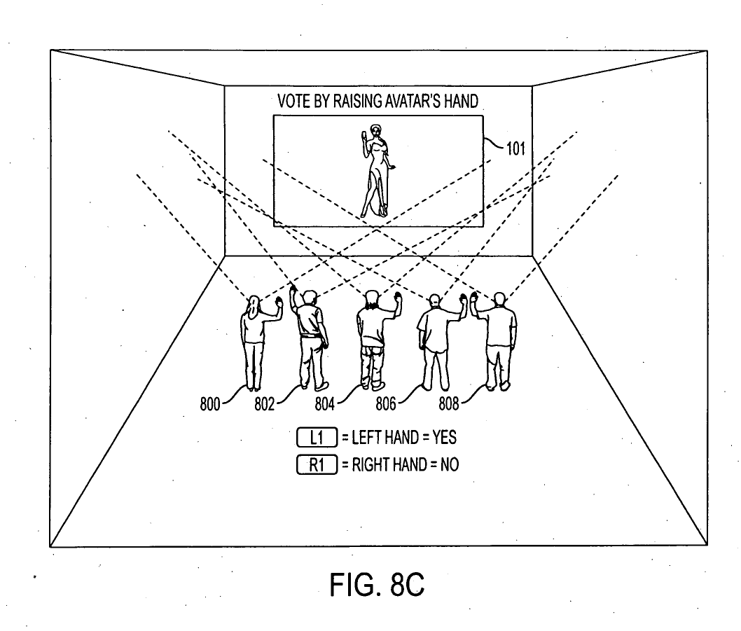

FIG. 8A illustrates an embodiment where users within a virtual room may be prompted to vote as to their likes or dislikes, regarding a specific ad 101. In this example, users 102b and 104b may move onto either a YES area or a NO area. User 102b′ is now standing on YES and user 104b′ is now standing on NO. This feedback is monitored, and is easily captured, as users can simply move to different locations within a scene to display their approval, disapproval, likes, dislikes, etc. Similarly, FIG. 8B shows users moving to different parts of the room to signal their approval or disapproval, or likes or dislikes. As shown, users 800 and 802 are already in the YES side of the room, while users 804 and 806 are in the NO side of the room. User 808 is shown changing his mind or simply moving to the YES side of the room. FIG. 8C shows an example of users 800-808 voting YES or NO by raising their left or right hands. These parts of the user avatar bodies can be moved by simply selecting the correct controller buttons (e.g., L1, R1, etc.).

In one embodiment, the virtual world program may be executed partially on a server connected to the internet and partially on the local computer (e.g., game console, desktop, laptop, or wireless hand held device). Still further, the execution can be entirely on a remote server or processing machine, which provides the execution results to the local display screen. In this case, the local display or system should have minimal processing capabilities to receive the data over the network (e.g., like the Internet) and render the graphical data on the screen.

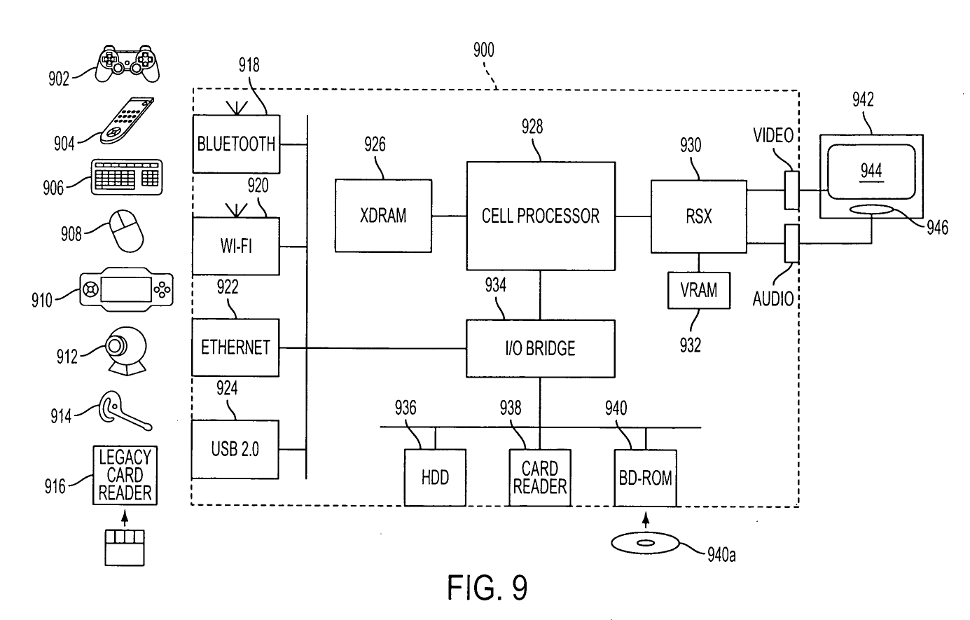

FIG. 9 schematically illustrates the overall system architecture of the Sony® Playstation 3® entertainment device, a console having controllers for implementing an avatar control system in accordance with one embodiment of the present invention. A system unit 900 is provided, with various peripheral devices connectable to the system unit 900. The system unit 900 comprises: a Cell processor 928; a Rambus® dynamic random access memory (XDRAM) unit 926; a Reality Synthesizer graphics unit 930 with a dedicated video random access memory (VRAM) unit 932; and an I/O bridge 934. The system unit 900 also comprises a Blu Ray® Disk BD-ROM® optical disk reader 940 for reading from a disk 940a and a removable slot-in hard disk drive (HDD) 936, accessible through the I/O bridge 934. Optionally the system unit 900 also comprises a memory card reader 938 for reading compact flash memory cards, Memory Stick® memory cards and the like, which is similarly accessible through the I/O bridge 934.

The I/O bridge 934 also connects to six Universal Serial Bus (USB) 2.0 ports 924; a gigabit Ethernet port 922; an IEEE 802.11b/g wireless network (Wi-Fi) port 920; and a Bluetooth® wireless link port 918 capable of supporting of up to seven Bluetooth connections.

In operation the I/O bridge 934 handles all wireless, USB and Ethernet data, including data from one or more game controllers 902. For example when a user is playing a game, the I/O bridge 934 receives data from the game controller 902 via a Bluetooth link and directs it to the Cell processor 928, which updates the current state of the game accordingly.

The wireless, USB and Ethernet ports also provide connectivity for other peripheral devices in addition to game controllers 902, such as: a remote control 904; a keyboard 906; a mouse 908; a portable entertainment device 910 such as a Sony Playstation Portable® entertainment device; a video camera such as an EyeToy® video camera 912; and a microphone headset 914. Such peripheral devices may therefore in principle be connected to the system unit 900 wirelessly; for example the portable entertainment device 910 may communicate via a Wi-Fi ad-hoc connection, whilst the microphone headset 914 may communicate via a Bluetooth link.

The provision of these interfaces means that the Playstation 3 device is also potentially compatible with other peripheral devices such as digital video recorders (DVRs), set-top boxes, digital cameras, portable media players, Voice over IP telephones, mobile telephones, printers and scanners.

In addition, a legacy memory card reader 916 may be connected to the system unit via a USB port 924, enabling the reading of memory cards 948 of the kind used by the Playstation® or Playstation 2® devices.

In the present embodiment, the game controller 902 is operable to communicate wirelessly with the system unit 900 via the Bluetooth link. However, the game controller 902 can instead be connected to a USB port, thereby also providing power by which to charge the battery of the game controller 902. In addition to one or more analog joysticks and conventional control buttons, the game controller is sensitive to motion in six degrees of freedom, corresponding to translation and rotation in each axis. Consequently gestures and movements by the user of the game controller may be translated as inputs to a game in addition to or instead of conventional button or joystick commands. Optionally, other wirelessly enabled peripheral devices such as the Playstation Portable device may be used as a controller. In the case of the Playstation Portable device, additional game or control information (for example, control instructions or number of lives) may be provided on the screen of the device. Other alternative or supplementary control devices may also be used, such as a dance mat (not shown), a light gun (not shown), a steering wheel and pedals (not shown) or bespoke controllers, such as a single or several large buttons for a rapid-response quiz game (also not shown).

The remote control 904 is also operable to communicate wirelessly with the system unit 900 via a Bluetooth link. The remote control 904 comprises controls suitable for the operation of the Blu Ray Disk BD-ROM reader 940 and for the navigation of disk content.

The Blu Ray Disk BD-ROM reader 940 is operable to read CD-ROMs compatible with the Playstation and PlayStation 2 devices, in addition to conventional pre-recorded and recordable CDs, and so-called Super Audio CDs. The reader 940 is also operable to read DVD-ROMs compatible with the Playstation 2 and PlayStation 3 devices, in addition to conventional pre-recorded and recordable DVDs. The reader 940 is further operable to read BD-ROMs compatible with the Playstation 3 device, as well as conventional pre-recorded and recordable Blu-Ray Disks.

The system unit 900 is operable to supply audio and video, either generated or decoded by the Playstation 3 device via the Reality Synthesizer graphics unit 930, through audio and video connectors to a display and sound output device 942 such as a monitor or television set having a display 944 and one or more loudspeakers 946. The audio connectors 950 may include conventional analogue and digital outputs whilst the video connectors 952 may variously include component video, S-video, composite video and one or more High Definition Multimedia Interface (HDMI) outputs. Consequently, video output may be in formats such as PAL or NTSC, or in 720p, 10801 or 1080p high definition.

Audio processing (generation, decoding and so on) is performed by the Cell processor 928. The Playstation 3 device's operating system supports Dolby® 5.1 surround sound, Dolby® Theatre Surround (DTS), and the decoding of 7.1 surround sound from Blu-Ray® disks.

In the present embodiment, the video camera 912 comprises a single charge coupled device (CCD), an LED indicator, and hardware-based real-time data compression and encoding apparatus so that compressed video data may be transmitted in an appropriate format such as an intra-image based MPEG (motion picture expert group) standard for decoding by the system unit 900. The camera LED indicator is arranged to illuminate in response to appropriate control data from the system unit 900, for example to signify adverse lighting conditions. Embodiments of the video camera 912 may variously connect to the system unit 900 via a USB, Bluetooth or Wi-Fi communication port. Embodiments of the video camera may include one or more associated microphones and also be capable of transmitting audio data. In embodiments of the video camera, the CCD may have a resolution suitable for high-definition video capture. In use, images captured by the video camera may for example be incorporated within a game or interpreted as game control inputs.

In general, in order for successful data communication to occur with a peripheral device such as a video camera or remote control via one of the communication ports of the system unit 900, an appropriate piece of software such as a device driver should be provided. Device driver technology is well-known and will not be described in detail here, except to say that the skilled man will be aware that a device driver or similar software interface may be required in the present embodiment described.

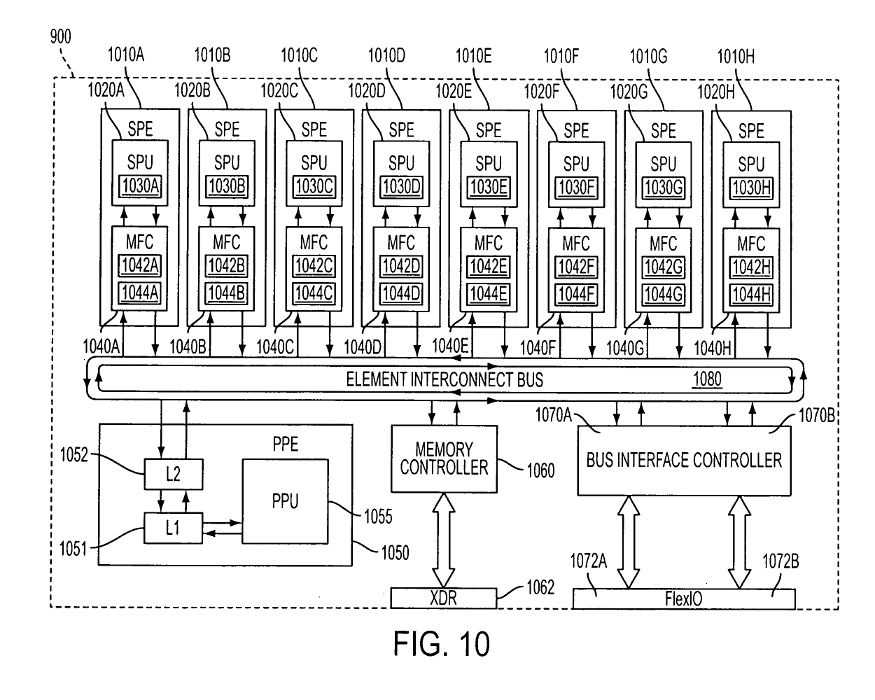

FIG. 10 is a schematic of the Cell processor 928 in accordance with one embodiment of the present invention. The Cell processors 928 has an architecture comprising four basic components: external input and output structures comprising a memory controller 1060 and a dual bus interface controller 1070A,B; a main processor referred to as the Power Processing Element 1050; eight co-processors referred to as Synergistic Processing Elements (SPEs) 1010A-H; and a circular data bus connecting the above components referred to as the Element Interconnect Bus 1080. The total floating point performance of the Cell processor is 218 GFLOPS, compared with the 6.2 GFLOPs of the Playstation 2 device's Emotion Engine.

The Power Processing Element (PPE) 1050 is based upon a two-way simultaneous multithreading Power 970 compliant PowerPC core (PPU) 1055 running with an internal clock of 3.2 GHz. It comprises a 512 kB level 2 (L2) cache and a 32 kB level 1 (L1) cache. The PPE 1050 is capable of eight single position operations per clock cycle, translating to 25.6 GFLOPs at 3.2 GHz. The primary role of the PPE 1050 is to act as a controller for the Synergistic Processing Elements 1010A-H, which handle most of the computational workload. In operation the PPE 1050 maintains a job queue, scheduling jobs for the Synergistic Processing Elements 1010A-H and monitoring their progress. Consequently each Synergistic Processing Element 1010A-H runs a kernel whose role is to fetch a job, execute it and synchronizes with the PPE 1050.

Each Synergistic Processing Element (SPE) 1010A-H comprises a respective Synergistic Processing Unit (SPU) 1020A-H, and a respective Memory Flow Controller (MFC) 1040A-H comprising in turn a respective Dynamic Memory Access Controller (DMAC) 1042A-H, a respective Memory Management Unit (MMU) 1044A-H and a bus interface (not shown). Each SPU 1020A-H is a RISC processor clocked at 3.2 GHz and comprising 256 kB local RAM 1030A-H, expandable in principle to 4 GB. Each SPE gives a theoretical 25.6 GFLOPS of single precision performance. An SPU can operate on 4 single precision floating point members, 4 32-bit numbers, 8 16-bit integers, or 16 8-bit integers in a single clock cycle. In the same clock cycle it can also perform a memory operation. The SPU 1020A-H does not directly access the system memory XDRAM 926; the 64-bit addresses formed by the SPU 1020A-H are passed to the MFC 1040A-H which instructs its DMA controller 1042A-H to access memory via the Element Interconnect Bus 1080 and the memory controller 1060.

The Element Interconnect Bus (EIB) 1080 is a logically circular communication bus internal to the Cell processor 928 which connects the above processor elements, namely the PPE 1050, the memory controller 1060, the dual bus interface 1070A,B and the 8 SPEs 1010A-H, totaling 12 participants. Participants can simultaneously read and write to the bus at a rate of 8 bytes per clock cycle. As noted previously, each SPE 1010A-H comprises a DMAC 1042A-H for scheduling longer read or write sequences. The EIB comprises four channels, two each in clockwise and anti-clockwise directions. Consequently for twelve participants, the longest step-wise data-flow between any two participants is six steps in the appropriate direction. The theoretical peak instantaneous EIB bandwidth for 12 slots is therefore 96B per clock, in the event of full utilization through arbitration between participants. This equates to a theoretical peak bandwidth of 307.2 GB/s (gigabytes per second) at a clock rate of 3.2 GHz.

The memory controller 1060 comprises an XDRAM interface 1062, developed by Rambus Incorporated. The memory controller interfaces with the Rambus XDRAM 926 with a theoretical peak bandwidth of 25.6 GB/s.

The dual bus interface 1070A,B comprises a Rambus FlexIO® system interface 1072A,B. The interface is organized into 12 channels each being 8 bits wide, with five paths being inbound and seven outbound. This provides a theoretical peak bandwidth of 62.4 GB/s (36.4 GB/s outbound, 26 GB/s inbound) between the Cell processor and the I/O Bridge 700 via controller 170A and the Reality Simulator graphics unit 200 via controller 170B.

Data sent by the Cell processor 928 to the Reality Simulator graphics unit 930 will typically comprise display lists, being a sequence of commands to draw vertices, apply textures to polygons, specify lighting conditions, and so on.

Embodiments may include capturing depth data to better identify the real-world user and to direct activity of an avatar or scene. The object can be something the person is holding or can also be the person's hand. In the this description, the terms “depth camera” and “three-dimensional camera” refer to any camera that is capable of obtaining distance or depth information as well as two-dimensional pixel information. For example, a depth camera can utilize controlled infrared lighting to obtain distance information. Another exemplary depth camera can be a stereo camera pair, which triangulates distance information using two standard cameras. Similarly, the term “depth sensing device” refers to any type of device that is capable of obtaining distance information as well as two-dimensional pixel information.

Recent advances in three-dimensional imagery have opened the door for increased possibilities in real-time interactive computer animation. In particular, new “depth cameras” provide the ability to capture and map the third-dimension in addition to normal two-dimensional video imagery. With the new depth data, embodiments of the present invention allow the placement of computer-generated objects in various positions within a video scene in real-time, including behind other objects.

Moreover, embodiments of the present invention provide real-time interactive gaming experiences for users. For example, users can interact with various computer-generated objects in real-time. Furthermore, video scenes can be altered in real-time to enhance the user's game experience. For example, computer generated costumes can be inserted over the user's clothing, and computer generated light sources can be utilized to project virtual shadows within a video scene. Hence, using the embodiments of the present invention and a depth camera, users can experience an interactive game environment within their own living room. Similar to normal cameras, a depth camera captures two-dimensional data for a plurality of pixels that comprise the video image. These values are color values for the pixels, generally red, green, and blue (RGB) values for each pixel. In this manner, objects captured by the camera appear as two-dimension objects on a monitor.

Embodiments of the present invention also contemplate distributed image processing configurations. For example, the invention is not limited to the captured image and display image processing taking place in one or even two locations, such as in the CPU or in the CPU and one other element. For example, the input image processing can just as readily take place in an associated CPU, processor or device that can perform processing; essentially all of image processing can be distributed throughout the interconnected system. Thus, the present invention is not limited to any specific image processing hardware circuitry and/or software. The embodiments described herein are also not limited to any specific combination of general hardware circuitry and/or software, nor to any particular source for the instructions executed by processing components.

With the above embodiments in mind, it should be understood that the invention may employ various computer-implemented operations involving data stored in computer systems. These operations include operations requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

The above described invention may be practiced with other computer system configurations including hand-held devices, microprocessor systems, microprocessor-based or programmable consumer electronics, minicomputers, mainframe computers and the like. The invention may also be practiced in distributing computing environments where tasks are performed by remote processing devices that are linked through a communications network.

The invention can also be embodied as computer readable code on a computer readable medium. The computer readable medium is any data storage device that can store data which can be thereafter read by a computer system, including an electromagnetic wave carrier. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer system so that the computer readable code is stored and executed in a distributed fashion.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A method for enabling interactive control and monitoring of avatars in a computer generated virtual world environment, comprising:
generating a graphical animated environment;
presenting a viewable object within the graphical animated environment;
moving an avatar within the graphical animated environment, the moving includes directing a field of view of the avatar toward the viewable object;
detecting a response of the avatar when the field of view of the avatar is directed toward the viewable object; and
storing the response;
wherein the response is analyzed to determine whether the response is more positive or more negative.

2. A method for enabling interactive control and monitoring of avatars in a computer generated virtual world environment as recited in claim 1, wherein the viewable object is an advertisement.

3. A method for enabling interactive control and monitoring of avatars in a computer generated virtual world environment as recited in claim 1, wherein the advertisement is animated in a virtual space of the graphical animated environment.

4. A method for enabling interactive control and monitoring of avatars in a computer generated virtual world environment as recited in claim 1, wherein a real-world user is moving the avatar within the graphical animated environment, and further comprising;
detecting audible sound from the real-world user;
analyzing the audible sound to determine if the audible sound relates to one of emotions, laughter, utterances, or a combination thereof; and
defining the analyzed audible sound to signify the response to be more positive or more negative.

5. A method for enabling interactive control and monitoring of avatars in a computer generated virtual world environment as recited in claim 1, wherein the response is triggered by a button of a controller.

6. A method for enabling interactive control and monitoring of avatars in a computer generated virtual world environment as recited in claim 4, wherein selected buttons of the controller trigger one or more of facial expressions, bodily expressions, verbal expressions, body movements, comments, or a combination of two or more thereof.

7. A method for enabling interactive control and monitoring of avatars in a computer generated virtual world environment as recited in claim 6, wherein the response is analyzed and presented to owners of the advertisements and operators of the graphical animated environment.

8. A computer implemented method for executing a network application, the network application defined to render a virtual environment, the virtual environment being depicted by computer graphics, comprising:
generating an animated user;
controlling the animated user in the virtual environment;
presenting advertising objects in the virtual environment;
detecting actions by the animated user to determine if the animated user is viewing one of the advertising object in the virtual environment;
capturing reactions by the animated user when the animated user is viewing the advertising object;
wherein the reactions by the animated user within the virtual environment are those that relate to the advertising object, and are presented to a third party to determine effectiveness of the advertising object in the virtual environment.

9. A computer implemented method for executing a network application as recited in claim 8, wherein the third party is an advertiser of a product or service.

10. A computer implemented method for executing a network application as recited in claim 8, wherein the third part is an operator of the virtual environment.

11. A computer implemented method for executing a network application as recited in claim 10, wherein the operator of the virtual environment defines advertising cost formulas for the advertising objects.

12. A computer implemented method for executing a network application as recited in claim 11, wherein the cost formulas define rates charged to advertisers based on user reactions that relate to specific advertising objects.

13. A computer implemented method for executing a network application as recited in claim 8, wherein the captured reactions include animated user facial expressions, animated user voice expressions, animated user body movements, or combinations thereof.

14. A computer implemented method for executing a network application as recited in claim 8, wherein the advertisement object is animated in a virtual space of the virtual environment.

15. A computer implemented method for executing a network application as recited in claim 8, wherein the reactions are triggered by a button of a controller.

16. A computer implemented method for executing a network application as recited in claim 15, wherein selected buttons of the controller trigger, on the animated user, one or more of facial expressions, bodily expressions, verbal expressions, body movements, comments, or a combination of two or more thereof.

17. A computer implemented method for executing a network application as recited in claim 16, wherein the reaction is analyzed and presented to owners of the advertisements and operators of the virtual environment.

18. A computer implemented method for executing a network application as recited in claim 8, wherein the reaction is analyzed to determine whether the response is more positive or more negative.

19. A computer implemented method for executing a network application, the network application defined to render a virtual environment, the virtual environment being depicted by computer graphics, comprising:
generating an animated user;
controlling the animated user in the virtual environment;
presenting advertising objects in the virtual environment;
detecting actions by the animated user to determine if the animated user is viewing one of the advertising object in the virtual environment;
capturing reactions by the animated user when the animated user is viewing the advertising object;
wherein the reactions by the animated user within the virtual environment are those that relate to the advertising object, and are presented to a third party to determine if the reactions are more positive or more negative.

20. A computer implemented method for executing a network application as recited in claim 19, further comprising:
determining a vote by the animated user, the vote signifying approval or disapproval of a specific one of the advertising objects.

21. A computer implemented method for executing a network application as recited in claim 19, wherein the third part is an operator of the virtual environment, and the operator of the virtual environment defines advertising cost formulas for the advertising objects.

22. A computer implemented method for interfacing with a computer program, the computer program being configured to at least partially execute over a network, the computer program defining a graphical environment of virtual places and the computer program enabling a real-world user to control an animated avatar in and around the graphical environment of virtual places, comprising;
assigning the real-world user to control the animated avatar;
moving the animated avatar in and around the graphical environment;
detecting real-world reactions by the real-world user in response to moving the animated avatar in and around the graphical environment;
identifying the real-world reactions;
mapping the identified real-world reactions to the animated avatar;
wherein the animated avatar graphically displays the real-world reactions on a display screen that is executing the computer program.

23. A computer implemented method for interfacing with a computer program as recited in claim 22, wherein the identified real-world reactions are analyzed based on content within the virtual spaces that the animated avatar is viewing.

24. A computer implemented method for interfacing with a computer program as recited in claim 22, wherein the content is a product or service advertised within the graphical environment of virtual places.

25. A computer implemented method for interfacing with a computer program as recited in claim 22, wherein an operator of the computer program defines advertising cost formulas for advertising.

26. A computer implemented method for interfacing with a computer program as recited in claim 25, wherein the cost formulas define rates charged to advertisers based on viewing or reactions that relate to specific advertising.
